(19) United States
(12) Patent Application Publication
(10) Pub. No.: US 2010/0010849 A1
(43) Pub. Date: Jan. 14, 2010

(54) METHOD AND SYSTEM FOR TAX RISK ASSESSMENT AND CONTROL

(76) Inventor: Geralyn R. Hurd, Chicago, IL (US)

Correspondence Address: BOSE MCKINNEY & EVANS LLP, 111 MONUMENT CIRCLE, SUITE 2700, INDIANAPOLIS, IN, 46204, US

(21) Appl. No.: 12/171,881

(22) Filed: Jul. 11, 2008

(51) Int. Cl. G06Q 40/00; G06Q 10/00

(52) U.S. Cl. 705/7; 705/31

(57) ABSTRACT

A method of determining an enterprise risk for a tax exempt entity based upon data required to complete a tax form. The method includes the steps of organizing the data into a plurality of categories to determine areas of risk related to public relations and to tax exempt status.

### BACKGROUND OF THE INVENTION

The present invention relates generally to methods and systems of preparing tax forms filed by individuals, corporations, and non-profit organizations to comply with the applicable tax laws. More particularly, the invention relates to a method and system for complying with tax laws as well as a method and system for providing a reasoned analysis of that compliance and risk assessment.

The U.S. government through the Internal Revenue Service requires an exempt organization to annually file an information report (Form 990). The Internal Revenue Service has made a significant revision to Form 990, entitled Return of Organization Exempt from Income Tax, a copy of which can be found in Appendix A, which is herein incorporated by reference in its entirety. This revision is far-reaching and has been made for the first time since 1979 in order to keep pace with changes in the law and with the increasing size, diversity, and complexity of the exempt sector. Form 990 was revised in part because it failed to meet the Internal Revenue Service's tax compliant interests or the transparency and accountability needs of the states, the public and local communities served by a non-profit organization. Because the Form 990 has been significantly revised, the amount of information necessary to be collected to complete the form has also been greatly increased. In addition, not only has the amount of information required to fill out the form been increased, but the scope and tenor of the type of information has also changed.

When considering a tax exempt corporation, there are two key enterprise risks to consider. The first key enterprise risk is related to public relations. Form 990 is the most comprehensive source of information regarding a tax exempt organization available to the general public. Stake holders in the enterprise as well as individuals and the media have access to an organization's information through a number of publicly available sources of information such as Guidestar of Williamsburg, Va. The second key enterprise risk for an exempt organization is related to the maintenance of an enterprise's exempt status. IRS Form 990 is no longer just an accounting report. It also includes a report of activities which the federal government considers to be important for maintaining tax exempt status. The IRS has requested, through the completed form, information regarding governance structure, enterprise policies and practices, and operations of the enterprise. The IRS and state and local taxing authorities can use the IRS Form 990 to assess compliance with the law and adherence to the missions and practices which have been adopted by the exempt organization.

### SUMMARY OF THE INVENTION

The present invention relates to a system and method for assessing risks for a tax exempt organization based upon information submitted for preparation of Form 990. An analysis of the information submitted in response to requests for information and to questions of Form 990 can be used to determine key areas of risk. The information can be used to enable an enterprise to effectively manage its organization not only from a public relations viewpoint but as well as the maintenance of tax exempt status. The requests for information, questions and the provided information from Form 990 are grouped into a number of key areas of risk.

The key areas of risks which have been identified as components or categories are demographics, governance, compensation, conflicts of interest, financial analysis, compliance with federal, state, and local requirements, and activities. A weighting table includes weighted values for information and for possible answers provided by the user in response to questions grouped according to each of the key areas or components. The system assigns a weighted value to the answers and information provided by the user to establish a risk factor which can be used in discussions with the tax exempt entity to determine which potential areas of risk exist. The answers and information are also used to complete the Form 990 for reporting to the IRS as well as for determining any specific tax liability.

In accordance with one aspect of the present invention, there is provided a method of determining a risk for a tax exempt entity based upon information provided in response to questions associated with a tax form having a plurality of schedules. The method includes defining a plurality of categories of questions associated with the tax form and schedules, organizing the information into the plurality of defined categories, assigning a risk factor to information to be provided in response to each of the questions and determining a risk range for each the plurality of categories to provide an indication of risk based on the assigned risk factors.

Pursuant to another aspect of the present invention there is provided a method of determining an enterprise risk for a tax exempt entity based upon responses required to complete an electronic tax form having multiple schedules, each schedule having a request for information. The method includes organizing the requests for information into a plurality of categories, receiving responses input to an electronic questionnaire, assigning a risk factor for each of the received responses, creating a risk range for each the plurality of categories to provide an indication of risk, computing a risk score for each of the plurality of categories using the assigned risk factors, and comparing the computed risk score to the risk range.

Pursuant to still another aspect of the present invention, there is provided a tax risk assessment system for use with a computer network and for assessing a tax risk for a tax exempt entity. The system includes a computer server, coupled to the computer network. The computer server includes a software application to assess a tax risk based on information provided to complete a tax form filed by non-profit organizations, the tax form including a plurality of schedules. A computing device can be coupled to the computer network. The computing device includes a user interface to review the software application and to provide information to the software application, wherein the software application includes a program that when executed generates information to complete the tax form, a diagnostic report, and a risk assessment report.

Additional features and advantages of the invention will become apparent to those skilled in the art upon consideration of the following detailed description of the illustrated embodiments.

### BRIEF DESCRIPTION OF THE DRAWINGS

Aspects of the present invention are more particularly described below with reference to the following figures which illustrate exemplary embodiments of the present invention.

FIG. 1 is a top level functional diagram of the present invention for an exemplary organizational scheme.

FIG. 2 is a flow diagram of one embodiment of the present invention.

FIG. 3A-D is a more detailed flow diagram of the present invention.

FIG. 4 is a chart illustrating the various schedules of Form 990 and how each of the components includes a variety of questions from that form.

FIG. 5 is a risk score chart used to determine risks for each of the various components.

FIG. 6 is a block diagram of a system according to the present invention.

### DETAILED DESCRIPTION OF THE PRESENT INVENTION

The embodiments of the present invention described below are not intended to be exhaustive or to limit the invention to the precise forms disclosed in the following detailed description. Rather the embodiments are chosen and described so that others skilled in the art may appreciate and understand the principals and practices of the present invention.

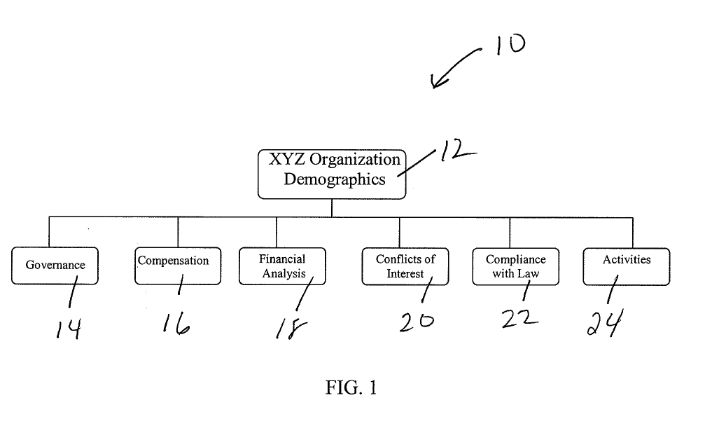

FIG. 1 illustrates a top level functional diagram of the present invention. Because the Internal Revenue Service has significantly expanded the amount of information now required on a tax exempt organization's annual tax filing, the present invention includes a categorization of the information used to complete the various parts and schedules which can be found in Form 990. Information includes any data whether alphabetical or numerical used to respond to requests for information and to questions posed. The categorization enables a review along the lines of seven key components or categories. As can be seen in FIG. 1, an organizational chart 10 for the XYZ organization illustrates that the organization's operations can be described based on the organization's demographics 12, one of the key components. Once the demographics 12 are understood, additional information provided when Form 990 is completed can be organized into an additional six key components of: governance component 14, compensation component 16, financial analysis component 18, conflicts of interest component 20, compliance with the law component 22 and activities component 24. By analyzing each of these six key components as well as the demographics of an organization through the use of Form 990, a tax exempt organization can understand and address, if necessary, the two key enterprise risks of public relations and maintenance of tax exempt status.

The risks associated with the key components can change depending on the organization's level of compliance with each component. Each of the key components has been identified based on an analysis of the type of information required to complete Form 990 and an understanding of the effect such responses can have with the Internal Revenue Service and the public. The compensation component 16 can have the biggest potential for creating an IRS problem or an adverse public reaction. For instance certain questions which can be relevant include: 1) Does an organization have compensation policies and is the organization in compliance with them?; 2) Do the compensation policies include not only base compensation, but travel and expense reimbursements, and other compensation as well?; 3) What perks are being offered?; 4) What is the approval process?; and 5) What information was used to determine compensation?.

The number of individuals for which compensation is being disclosed has been greatly expanded under the revised Form 990. For instance, the form now asks questions such as: 1) What is the number of individuals making more than $100,000?; 2) What is the number of independent contractors vs. employees and how does this relate to the calculation of FICA tax?; 3) What is the amount of donor dollars going to pay “excessive compensation?; (This amount is based on the reader's definition of “excessive”) and 4) Certain Public relations issues, such as: What's the officer to average employee salary?

For the conflicts of interest component 20, the Form 990 now requires information related to any relationship between and amongst board members as well as an “interested person” that can have a conflict. Vendor relationships with board members and arms-length transactions are also requested.

As for the compliance with the law component, the Form 990 requires information related to federal law, state tax law and international tax law. In particular, information related to federal law includes: 1) Employment taxes—analysis of independent contractors vs. employees; 2)Tax exempt bonds—determination of private use and compliance with arbitrage calculation; 3)Donor-advised fund compliance; 4)Alternative investments—compliance with disclosure requirements including Form 8865, Form 926, Form 8621, and Form 8865; 5)Nonqualified retirement plan—compliance with 409A; 6) Tax-sheltered annuity plans—compliance with 403(b); 7)Proper entity classification; and 8) Whether exempt status can be jeopardized by conducting prohibited activities.

For state tax law compliance issues, the required responses to Form 990 include state registrations, sales and use tax compliance, and unclaimed property compliance.

For international tax law compliance, the required responses include foreign activities—permanent establishment in foreign jurisdictions, foreign grants—compliance with the Patriot Act, and nonresident aliens.

For the governance component 14, the required responses can include whether the organization includes an active and engaged board and if a problem occurs, whether there is an oversight structure that would be able to self-identify the problem and correct it prior to any IRS involvement.

The financial analysis component 18 can use audited information to determine whether such information might trigger a review by the IRS or signal potential problems with public relations. Some of the information which can trigger a review or signal potential problems includes: 1) Revenue diversification—How is the organization making their money? Is it consistent with the exempt purpose? Is there too much investment or unrelated business income?; 2) Statement of functional expenses—Is a substantial portion of the organization's budget being spent to promote the mission of the organization? How much money is being spent to raise a dollar? How much management/general to overall budget? Salaries?; 3) Public support test for public charities—Is the entity still in compliance with the entity type?; 4) Are there significant changes in program services?; and 5) Review of particular expense line items for excess benefit transactions.

The activities component 24 can be used to review a variety of the organization's activities which are now required as responses to Form 990. Such activities can include: 1) Are the political/lobbying activities appropriate for the entity type?; 2) Are there unrelated business income activities? How much income? Is the income calculated correctly? Are there expense allocations to unrelated business activities?; 3) What are the fundraising activities and are the solicitations appropriate? Are the compensation arrangements appropriate for the paid fundraisers? 4) Are any special events making money? Are the fundraising activities considered to be “gaming” activities?; 5) Is the value of charitable care and community benefit (for hospitals only) commensurate with the value of an organizations exempt status?; 6) Are the grant—making activities in both the U.S. and in foreign countries in compliance?; and 7) What is the organization doing with respect to foreign activity including any relationships with Expats/Inpats/Nonresident aliens. Is the organization in compliance with foreign law and treaties with U.S.?.

The present invention includes a software based system that runs on a computer and preferably runs over a network, allowing the users of the system, administrators, and other designated individuals or groups located remotely from one another to interface through a network computer system. The present invention includes a web based application which presents a variety of user interface screens as would be understood by one skilled in the art. The present invention can be run either remotely or locally. A remote embodiment could include running the present invention as a network application through a browser interface on a local computer with the software being installed on a remote system. A local embodiment could include running the present inventive system as a local application installed on a local computer in the user's office or company or building.

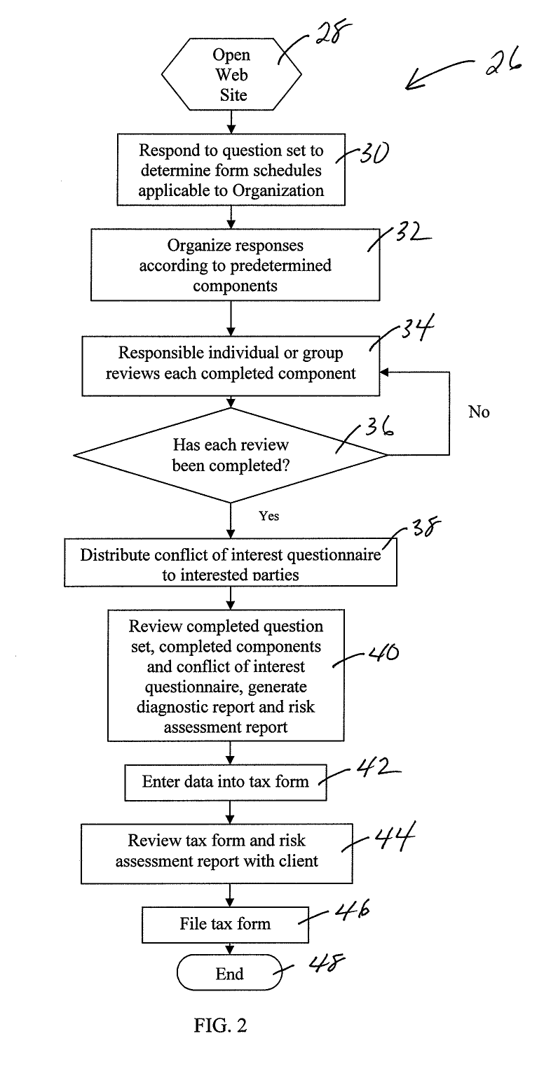

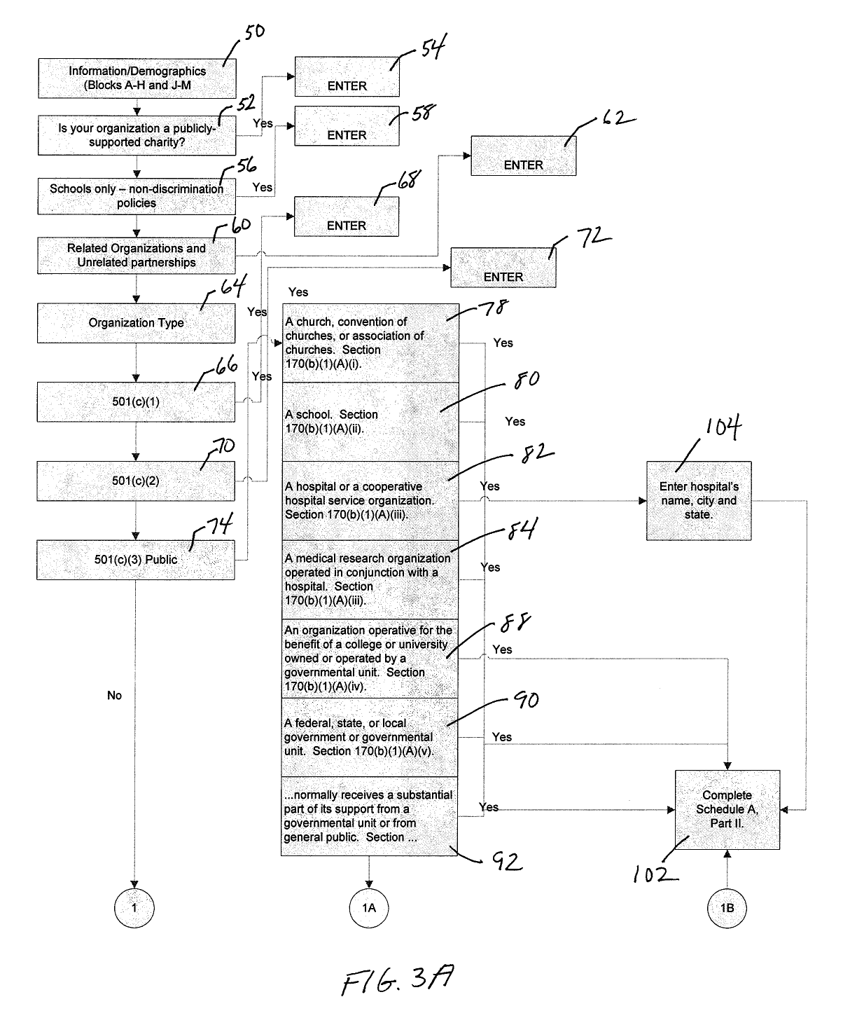

FIG. 2 illustrates one embodiment of a system 26 of the present invention. As described above and in this embodiment, the system includes a software based application which can be accessed through a computer by a user. The software based application includes a plurality of user interface screens which are displayed on a computer monitor or a lap top monitor requesting information to enable completion of the Form 990. At a first step 28, a user would open the website using a protected website address typically accessed with a user name and password which has been previously authorized by the administrator of the system. Once the website has been opened, the user at step 30 responds to a number of questions from a question set to determine the parts and schedules of the Form 990 applicable to the organization. Because Form 990 includes a core section as well as sixteen schedules, some of which may not be applicable to a particular organization, the question set in step 30 includes a number of questions which lead the preparer or user to fill out only those schedules which actually apply to the organization. Once the question set has been completed by a user, the responses are organized at step 32 according to the predetermined components of FIG. 1. Not only are the six identified components organized according to the answers provided to the question set, but the demographics portion of the system also uses that information.

Because the present invention can be embodied on a network based system, the various components 14, 16, 18, 20, 22, and 24 can be assigned by the user at step 34 to a responsible individual or group for review and completion, if necessary. For example, legal counsel can handle the governance component 14 and the conflicts component 20. A Controller can handle the financial components 18. Each of the individuals handling the various components can access the information through their personal work station and review the information contained within each component. Each of these components includes a predetermined series of tasks which the user has identified. The user can also determine whether or not each of the tasks within the various components has been completed. Once the user has designated the individuals at step 34, the user can enter the system at a later time to determine whether each review has been completed at step 36. If step 36 has not been completed by each of the assigned individuals or group, the user waits until the responsible individuals or groups have completed their review. Once each review of each component has been completed, the user distributes a conflict of interest questionnaire to interested parties at step 38. The conflict of interest questionnaire can be found in Appendix B which is part of a diagnostic report and which is incorporated herein by reference in its entirety. An interested party includes either an individual associated with the entity, an entity, or both that is a (1) current officer, director or key employee; (2) former officer, director or key employee depending on current compensation arrangements; and (3) the top five paid individuals outside of those groups listed in 1 and 2.

After completion of the conflict of interest questionnaire, a review is made at step 40 of the completed question set, the completed components and the conflict of interest questionnaire. After the review, a diagnostic report (See Appendix B) as well as an example of a risk assessment report (See Appendix C, herein incorporated by reference in its entirety) is generated. The diagnostic report of Appendix B illustrates the conflicts of interest portion of a complete diagnostic report. The complete diagnostic report can include a section for each of the key components and includes a listing of observations based on the responses given to the questionnaire. The user typically does not have access to the diagnostic report even though the user has facilitated the process of filling out the questionnaire for the completion of Form 990. Designated personnel within the company using their intimate knowledge of the client, access the diagnostics and make certain that the information provided by the user has been accurately presented.

Observations included in the diagnostic report are made in response to information received from the client. These observations can indicate that either the organization may be considered to be out of compliance with the law or that the presentation of its information will create an adverse public reaction. Some observations are generated as a result of a survey thread which is presented in the questionnaire. Other observations are formula-driven and based on the information received. Such formula driven observations can include 1) percentage of fundraising expenses to charitable contributions raised, 2) percentage of budget spent on management and general, 3) percentage of investment income or unrelated business income to the total revenue generated.

The following Table 1 illustrates a number of examples of observations and how those observations can relate to each of the six key components.

TABLE 1

| Component | Data Used | Observation |
|---|---|---|
| Compensation | Compensation policies - are their | Form 990, Page 6, Q 15 |
| | policies and is the organization in | Did the process for |
| | compliance with their policies | determining compensation |
| | Ratio of Highly Compensated | of the following persons |
| | Employees - Employees with | include a review and |
| | compensation >$100,000/total | approval by independent |
| | employees; | persons, comparability data, |
| | Officer, Director, Trustee Compensation | and contemporaneous |
| | to Average Employee Salary | substantiation of the |
| | Fringe Benefits -- Number of perks | deliberation and decision: 1) |
| | provided for interested persons on | The organization's CEO, |
| | Schedule J; Properly reported on Forms | Executive Director, or top |
| | W-2 or 1099? | management official? 2) |
| | Comparative Analysis -- Identification | Other officers or key |
| | of large swings in compensation items | employees of the |
| | noted on Schedule J. | organization? |
| | Additional Compensation Payments - | If no, then observation: |
| | what other arrangements does the | A significant exposure item |
| | organization have? | for tax exempt organization |
| | | is excessive compensation. |
| | | Finalized Treasury |
| | | Regulations (Sec. 4958) |
| | | provides for a safe harbor to |
| | | intermediate sanctions by |
| | | meeting a three-pronged test - |
| | | meeting the “rebuttable |
| | | presumption of |
| | | reasonableness”. This |
| | | presumption is met by 1) |
| | | Advance approval of the |
| | | board; 2) Reliance on |
| | | appropriate data; and 3) |
| | | Providing supportive |
| | | documentation. |
| | | The IRS looks at the |
| | | “rebuttable presumption” as |
| | | a significant item of |
| | | appropriate self-governance. |
| | | Without this, the |
| | | organization could be |
| | | subjected to further scrutiny |
| | | and potential penalties of: |
| | | 25 percent excise tax on the |
| | | individual who received the |
| | | benefit (plus return of the |
| | | excess benefit); |
| | | 200 percent excise tax on |
| | | the individual if the benefit |
| | | is not returned in a timely |
| | | manner; |
| | | 20 percent excise tax on the |
| | | board members who |
| | | approved the benefit |
| | | (includes noncompensated |
| | | volunteer board members). |
| Conflicts of | Collection of conflicts statements. Does | It does not appear that there |
| Interest | this organization have a significant | is adequate independence of |
| | number of business relationships with | the governing body. A |
| | their “interested persons”. What's the | significant number of the |
| | process of determining conflicts? What's | existing governing body are |
| | the process, once a conflict has been | conducting substantial |
| | identified to insure that transactions are | financial transactions with |
| | at arms-length? | the organization. |
| Compliance | Does your organization have a plan that | On Apr. 10, 2007, the |
| | provides for deferred compensation? | Treasury Department and |
| | Did any current officer, or employee | IRS issued final regulations |
| | listed earn or accrue more than $100,000 | regarding the deferred |
| | of non-qualified deferred compensation? | compensation rules under |
| | Have your deferred compensation plan | Section 409A of the Internal |
| | documents been reviewed for | Revenue Code (“409A”). |
| | compliance with 409A? | This requires that plan |
| | | documents be amended to |
| | | comply with this new code |
| | | section. It does not appear |
| | | that your documents are in |
| | | compliance with the new |
| | | regulations. Upon a 409A |
| | | violation, all compensation |
| | | deferred under the |
| | | applicable plan and all other |
| | | plans of the same type |
| | | during the year of the |
| | | violation and all preceding |
| | | taxable years is includable |
| | | in the taxable income of |
| | | participants affected by the |
| | | failure to comply. |
| Compliance | Questions regarding sales & use tax | It appears that the |
| | filings | organization is selling |
| | | tangible goods, but are not |
| | | in compliance with the |
| | | applicable sales & use tax |
| | | filing requirements. |
| Governance | See 33 principles for good governance | High priority risk - |
| | found in “Principles for Good | Of the 33 principles, fewer |
| | Governance and Ethical Practice”, Panel | than 1/3 seem to be in place |
| | on the Nonprofit Sector, Washington. | Risk |
| | D.C., October 2007. | Of the 33 principles, 60% |
| | | are in place |
| | | Best practice |
| | | Identification of remaining |
| | | principles not currently filed |
| Financial | Review of income statement, balance | % of program service |
| | sheet | expenses inadequate |
| | | Revenue diversification |
| | | ratios |
| Activities | Review of activities | Conducting prohibited |
| | | lobbying or political |
| | | activities |
| | | Unrelated business income |
| | | activities |
| | | Foreign activities |

Once the assessment of diagnostics and the review of information has been made, a designated individual or group can prepare a risk assessment report, an example of which can be found in Appendix C, which is herein incorporated by reference in its entirety.

After step 40 has been completed, the applicable data is entered by the system into the tax form, which in this case is Form 990. Entry of data in the tax form can be accomplished by a data mapping system as is understood by those skilled in the art which can be used to populate the various fields within the tax form. At step 44, the tax form and risk assessment report are generated and then reviewed with the client. Once finalized and approved by the client and the reviewer, the tax form is filed at step 46. Upon filing of the tax form 46 the process has been completed at step 48 for that particular tax year and that particular organization. Later revisions are however possible as would be understood by one skilled in the art.

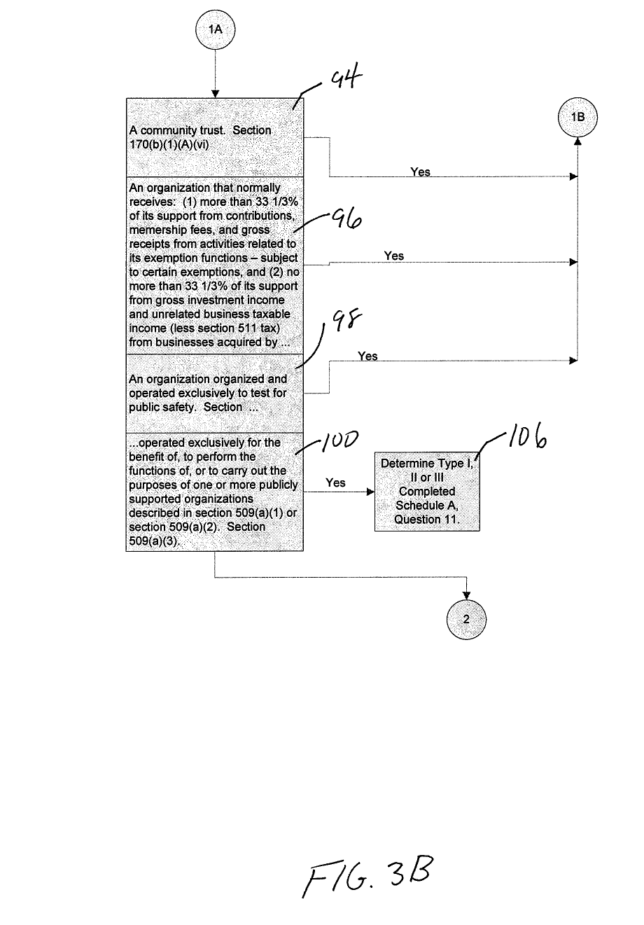

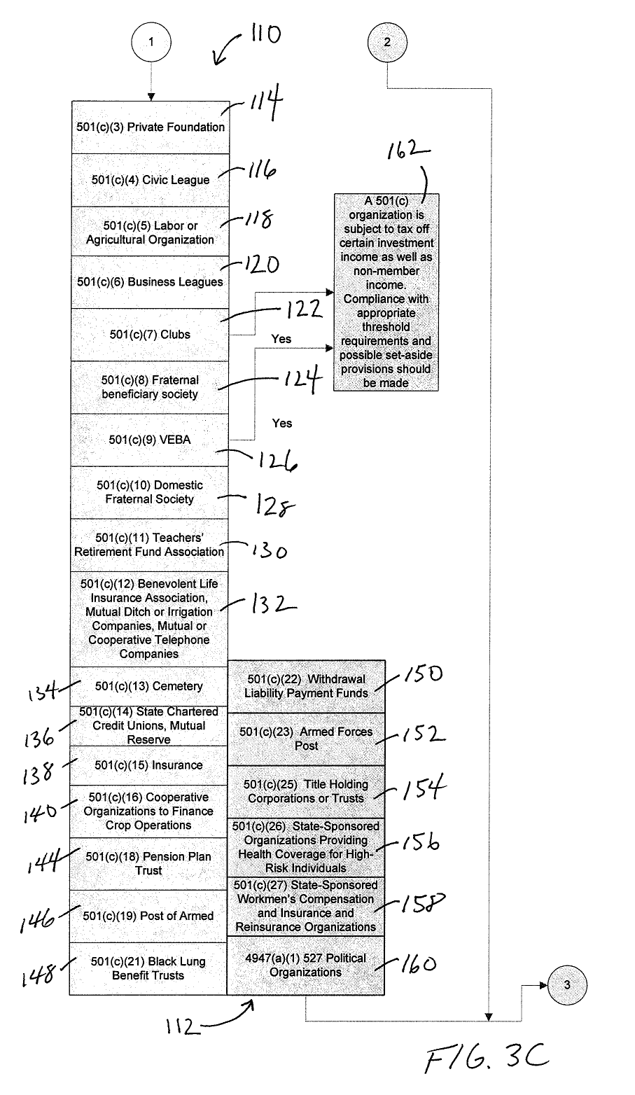

FIGS. 3A-3D illustrate a more detailed flow diagram of the present invention for completion of Form 990, completion of the diagnostic report, and completion of the risk assessment report, through completion of the question sets used in the present invention at step 30 of FIG. 2.

FIGS. 3A-3D include connecting circles labeled by numbers to indicate the flow of the diagram from one sheet to another.

In FIG. 3A at step 50, the application questionnaire requests information/demographics from the user which correspond to the information required in Form 990 for blocks A-H and J-M. Once this information has been provided to and received by the computer based system, at step 52 the question of whether the organization is a publicly supported charity is asked. If the answer is yes, then at step 54 the answer yes is entered into the system. After step 52, the question is asked for schools only whether or not the school includes a non discrimination policy. If the answer is yes then that information is entered at step 58. At step 60 the question is asked whether or not there are any related organizations and/or unrelated partnerships. If the answer is yes then that information is entered at step 62. Once these questions have been answered the application software proceeds to determining the organization type at step 64. The organization type can be a variety of types each of which will trigger a series of questions regarding those types including a number of sub-questions.

For instance, if the organization type is determined to be a 501(c)(1) organization at step 64, then that information is entered into the system at step 68. If the answer is no, then at that point the question is asked whether or not the organization is a 501(c)(2) type of organization at step 70. If the information is yes, then that information is entered at step 72. If the organization type is neither the 501(c)(1) or the 501(c)(2) type of organization, then the question is asked at step 74 whether or not the organization is a 501(c)(3) public organization. If the answer is yes, then a number of questions are asked to the user which appear in a column 76 illustrated in a central portion of FIG. 3A and continuing onto FIG. 3B.

Each of these questions presented to a user are labeled as questions 78, 80, 82, 84, 88, 90, 92, 94, 96, 98, and 100. These questions will not be repeated in this description but can be seen in FIGS. 3A and 3B. It is important to note that questions 78, 80, 84, 88, 90, 92, 94, 96, and 98 will each require the completion of Schedule A Part 2 at step 102 if the answer to those questions is yes. If the answer to the question 82 is yes, the question being that a hospital or a cooperative hospital service organization is being considered, then at step 104 the user must enter the hospital's name, city and state. Upon entry of that information, the user is directed to complete Schedule A Part 2. Also, as can be seen in FIG. 3B, if question 100 which states that the organization is operated exclusively for the benefit of, to perform the functions of, or carry out the purposes of one or more publicly supported organizations as described in certain sections of Section 509, then at that point the determination must be made as to whether or not the organization is a type 1, type 2 or type 3 organization at step 106. In addition, question 11 of Schedule A must also be completed.

Returning to FIG. 3A, if it is determined at step 74 that the organization is not a 501(c)(3) public organization, then the software application continues to ask and to determine the type of organization beginning at column 110 of FIG. 3C. Each of these organizations is listed in FIG. 3C at a left most column 110 and a partial central column 112 as illustrated. For instance, the questionnaire asks at step 114 whether or not the organization is a 501(c)(3) private foundation. Additional evenly numbered steps 116 through 160 are also completed as the questionnaire is filled in. As can be seen, each of these organizations is of a different type and can include for instance a civic league, a club, a teacher's retirement fund, a pension plan trust, and an Armed Forces post It is important to note at step 122 that if it is determined the organization is a 501(c)(7) club then at step 162 it is noted that since this type of organization is subject tax off of certain investment income as well as from non-member income compliance with the appropriate threshold requirements and possible set aside should be made. As can also be seen this same procedure, step 162, is set for step 126.

Once the part 1 questions summary has been completed at step 170 of FIG. 3D (see FIGS. 3A-3C), the information can be analyzed according to the prior described components which include the governance component 14 here shown as governance policies and oversight 172, the compensation component 16, here illustrated as compensation policies, attributes and compliance 174, the conflicts of interest component 20, here illustrated as conflicts of interest (distributable component), the financial analysis component 18 here illustrated as 178, the compliance with law component 22 here illustrated as compliance with federal and state requirements 180, and the activities component 24 here illustrated as activities analysis 182. Each of the components 172, 174, 176, 178, 180 and 182 each respectively include a number of questions which are here illustrated as columns extending below each of the described components. Each of the described part and question numbers refer to a specific part, schedule and question of Form 990 which are used to create an analysis of the entity being reviewed.

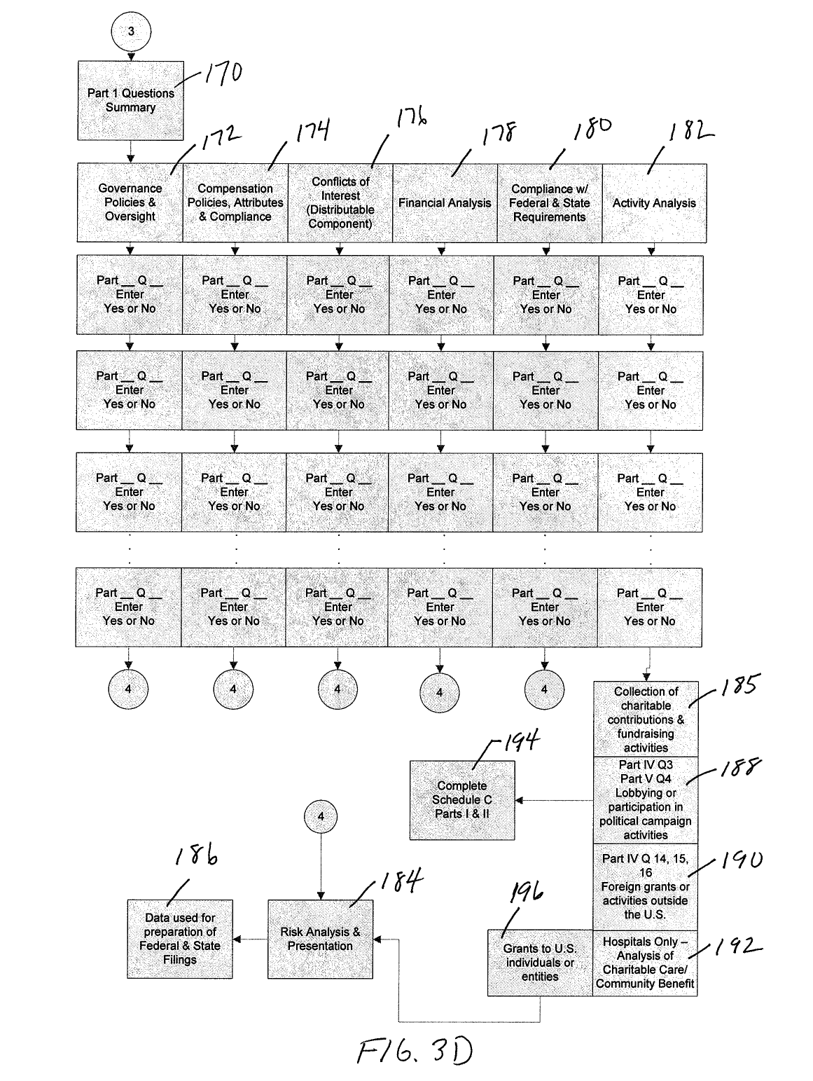

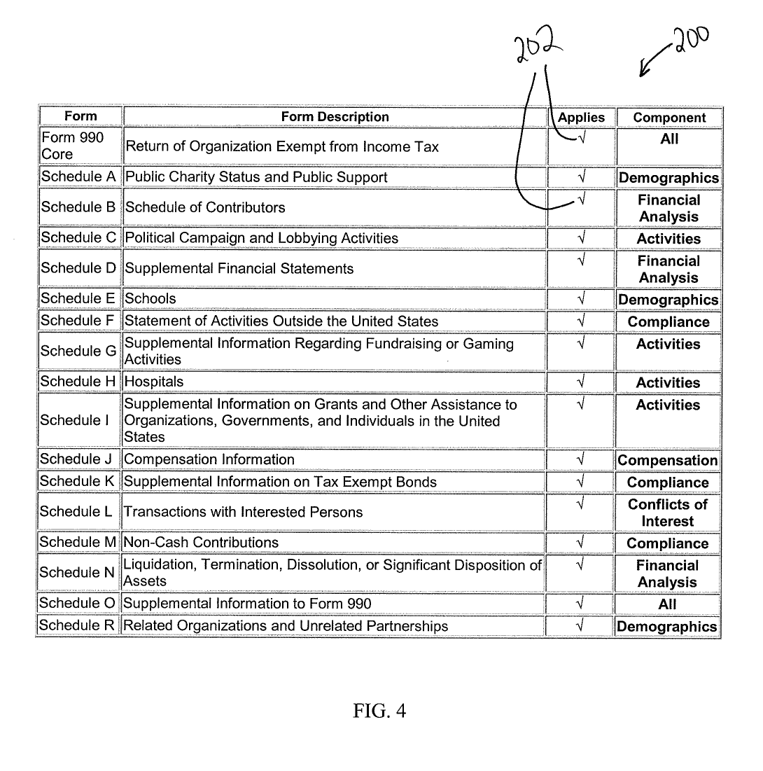

As illustrated in FIG. 4 in a form 200 provided as a part of the risk assessment report, it can generally be seen that the Form 990 includes a core section as well as Schedules A through 0 and Schedule R (See Appendix A). Each of the core and the schedules includes a Form Description indicating generally the content of that particular core or schedule. In addition, the present invention as described herein uses information from the core and each of the schedules to develop the various components. For instance, it can be seen that the core section, “Return of Organization Exempt from Income Tax”, includes information which applies to all six components and to demographics. Schedule A, “Public Charity Status and Public Support”, however, includes information which applies only to demographics. Likewise, the Schedule E, “Schools,” includes information applying only to demographics.

The form 200 also can include a column indicating which of the schedules includes a certain level of risk. For instance, if a schedule is indicated as including a risk, a flag can be set by the application program to indicate a risk exists. This flag can be used to create an indicator, such as a checkmark 202, to indicate to the reviewer and entity a risk exists.

It has been found that each of the schedules and core information includes data which can be organized according to components. Consequently, the schedules, parts, information requests, and questions have each been categorized according to the component to which that particular information applies. By categorizing this information under the various components, it has been found that an accurate analysis of the entity can be made providing the risks associated with the particular components. An example of the information used to create the conflicts of interest component can be found in Appendix B.

Returning to FIG. 3D, it can be seen that this information can be used to determine the risk analysis and presentation at step 184. Before step 184 can be completed, additional information is obtained in the activity analysis column 182 at steps 185, 188, 190, and 192. In particular, at step 188, Part IV, question 3 and Part V, question 4, it is determined whether there is lobbying or participation in a political campaign activity. If so, then Schedule C parts 1 and 2 at step 194 must be completed. Once each of these steps has been completed as well as step 196 indicating whether there have been any grants to U.S. individuals or entities, then the risk analysis and presentation part of the invention can be completed at step 184.

Once the risk analysis and presentation step 184 of FIG. 3D has been completed (corresponding to step 44 of FIG. 2), then at step 186, the data is used for the preparation and filing of federal and state tax returns corresponding to the file tax forms step 46 of FIG. 2.

To prepare the diagnostic report and risk assessment report of step 40 of FIG. 2 and ultimately to present the information to an entity at step 184 (also seen as step 44 of FIG. 2), the present invention evaluates the risks associated with the particular components. The information included in the answers to questions and organized according to component is also used to evaluate risks. It can be seen that the risk level associated with a particular component can change depending on the organization's level of compliance with each component. Each of the schedules, parts, and associated questions are given a risk number or factor which indicates a level of risk associated with the answer to a particular question. A high priority risk is given a risk factor of 3. The high priority risk is a risk generally indicating that the organization is out of compliance with federal, state or local law. The high priority risk factor of 3 also indicates that a risk has been identified and that the information provided would present an adverse public relations issue. A potential risk is given a risk factor of 2 which indicates that there is a risk that appears with the information provided and that there may be a problem. However, the information provided may not be sufficient to analyze the entire risk and as such it has been given a potential risk factor. The lowest risk factor is associated and is known as a best practices risk and is given a score of 1. The best practices risk indicates that while the organization is not out of compliance, the information presented does not give a favorable impression of the organization.

Each of the questions as previously described which has been organized within one of the six components as well as the demographic component has also been assigned a risk number from 1, 2, 3. One example of a portion of the diagnostic report which illustrates how the questions can be organized and selected from different sections of the Form 990 for inclusion within a single component can be seen in Appendix B. Appendix B includes the question set used for the conflicts of interest component 20 of the diagnostic report. As can be seen, a few questions from page 6, Part VI, Sections A and B are included. Responses to questions are indicted in the “Response Set” column. The requirement of an observation is indicated in the “Observation” column and the risk score assigned to the question is indicated in the “Weighting Table” column. The Conflicts of Interest questionnaire includes questions based on the information requested in Schedule L.

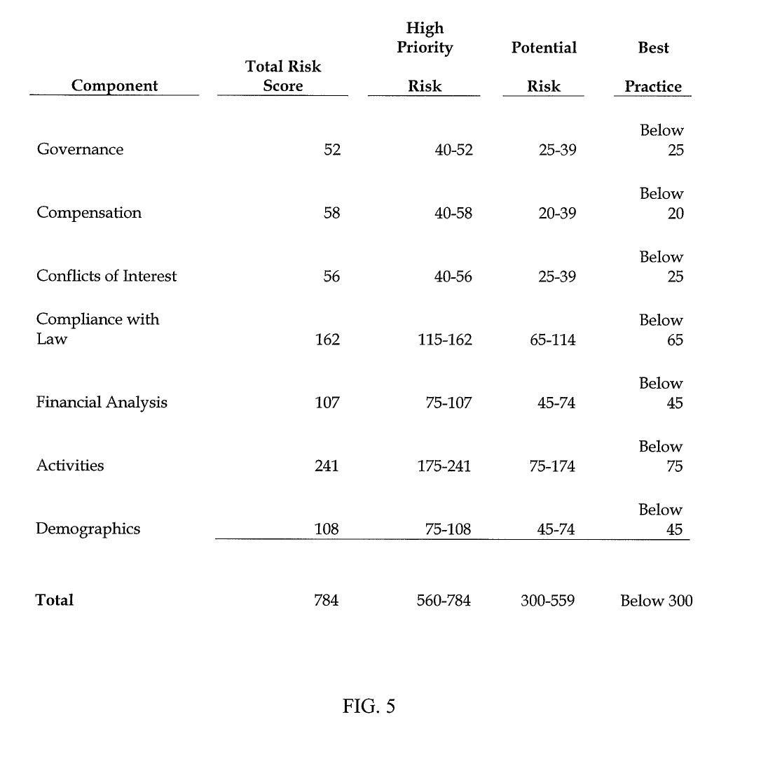

As illustrated in FIG. 5, each of the components includes a total risk score which results from adding up all of the risk numbers associated with the respective questions. The maximum governance total risk score is a 52, the maximum compensation risk score is a 58, the maximum conflicts of interest risk score is a 56, the maximum compliance with the law risk score is 162, the maximum financial analysis risk score is 107, the maximum activities risk score is 241, and the maximum demographics risk score is 108. The computer application analyzes the risk score for each of the components and uses a comparing algorithm or comparator to determine whether or not each of the components falls within a high priority risk, a potential risk, or a best practices risk. The total risk score resulting from the completed review is compared to the range of risks (risk range) shown in FIG. 5. For instance, if the total score for the governance component is a 46, then the risk would be considered a high priority risk since the range is from 40-52. If a risk is determined, a flag is set for use with the form 200 as previously described. While these scores are used in the present invention, such scores are not considered to be limiting and other scores are considered to be within the scope of the present invention.

FIG. 5 also illustrates a range of risk levels which indicate how each of the various components fall within one of the three overall risk scores. In addition, the computer application can also determine a total risk score as well as a total high priority risk score, a potential risk score, and a best practices risk score.

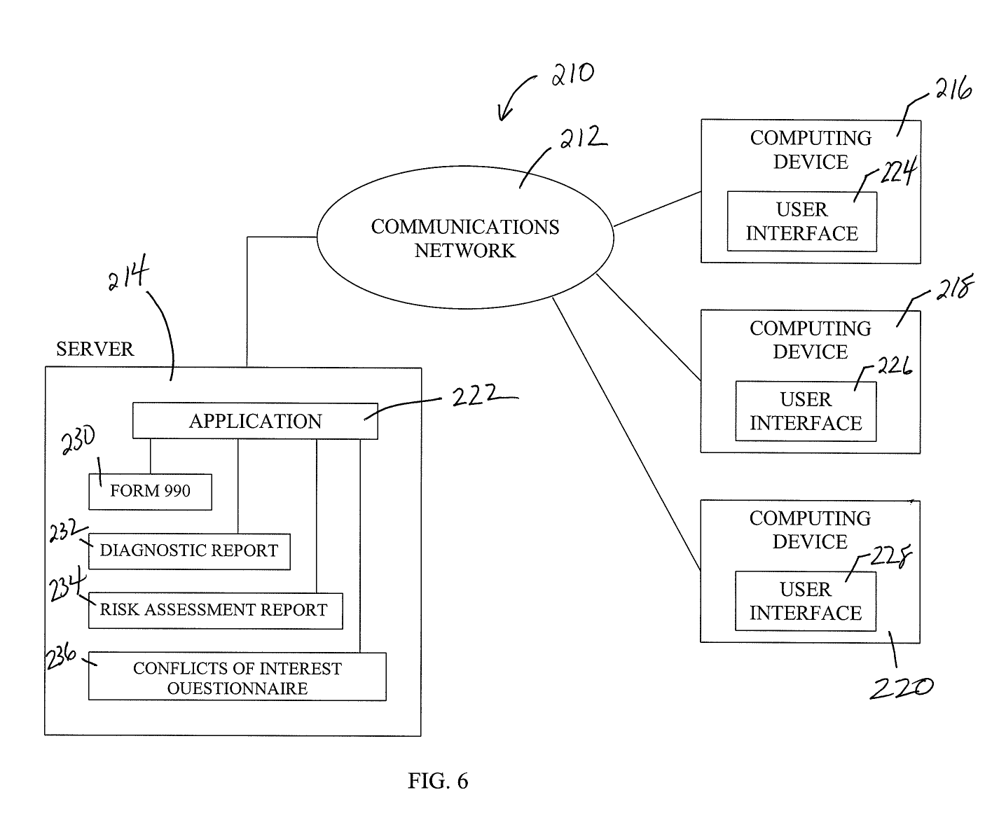

FIG. 6 is a block diagram of an exemplary embodiment a system 210 according to the present invention. The system 210 includes a communications network 212, a server computing device 214, and at least one or more of a plurality of client computing devices 216, 218, and 220. The communications network 210 operably couples the server computing device 214 to the at least one of the plurality of client computing devices 216, 218, 220 such that the server computing device 214 and the at least one of the plurality of client computing devices can share information according to the present invention. To this end, the communications network 210 can be the Internet, the World Wide Web, and/or any other suitable collection of devices that is connected to share information. It should be readily appreciated that the communications network 210 may include multiple public and/or private Local Area Networks (“LANs”) and/or Wide Area Networks (“WANs”) (not shown) that are operably coupled to one another via routers, switches, hubs, gateways, proxies, and/or firewalls (not shown). Additionally, it is noted that the communications network 210 may include a hardwired telephone network, a wireless telephone network, and/or a satellite network.

The server 214 includes the software application 222 of the present invention and as previously described. The software application 222 resides on the server 214 as would be understood by one skilled in the art. The application 214 can be accessed through one or more user interfaces 224, 226, and 228 located respectively on each of the computing devices 216, 218, and 220 as would be understood by one skilled in the art. A user located at one of the computing devices can access the application. The application 222 can be coupled to the electronic forms which include the Form 990 230, the diagnostic report 232, the risk assessment report 234, and the conflicts of interest questionnaire 236.

While exemplary embodiments incorporating the principles of the present teachings have been disclosed hereinabove, the present teachings are not limited to the disclosed embodiments. For instance, the present invention is not limited to six components and fewer or greater components are within the scope of the present invention. Instead, this application is intended to cover any variations, uses, or adaptations of the invention using its general principles. Further, this application is intended to cover such departures from the present disclosure as come within known or customary practice in the art to which this invention pertains.

What is claimed is:

1. A method of determining a risk for a tax exempt entity based upon information provided in response to questions associated with a tax form having a plurality of schedules, the method comprising:
defining a plurality of categories of questions associated with the tax form and schedules;
organizing the information into the plurality of defined categories;
assigning a risk factor to information to be provided in response to each of the questions; and
determining a risk range for each the plurality of categories to provide an indication of risk based on the assigned risk factors.

2. The method of claim 1, further comprising:
providing an electronic form, based on the tax form, to receive the information required to complete the tax form and schedules.

3. The method of claim 2, further comprising:
receiving information to populate each of the questions of the electronic form; and
generating a risk factor for each of the question having received data.

4. The method of claim 3, further comprising:
computing a risk score for each of the plurality of categories based on the generated risk factors;
comparing the computed risk score to the risk range; and
determining which of the plurality of categories includes a risk based on the compared computed risk score and the risk range.

5. The method of claim 4, further comprising:
generating a diagnostic report including a list of the plurality of schedules and an indicator associated with each of the plurality of schedules, to indicate which of the plurality of schedules includes a risk based on the determined risk.

6. The method of claim 5, wherein the generating step includes generating a diagnostic report including an observation for at least one of the plurality of categories.

7. The method of claim 6, wherein the generating step includes generating the observation automatically based on the received information.

8. The method of claim 7, further comprising:
moving the received information to an electronic tax form to complete the electronic tax form.

9. The method of claim 8, further comprising:
providing the diagnostic report and the completed electronic tax form to a user for review.

10. The method of claim 1, wherein the tax form comprises a tax form for organizations exempt from income.

11. The method of claim 10, wherein the organizing step includes the plurality of categories of governance, compensation, conflicts of interest, compliance with law, financial analysis, and activities.

12. A method of determining an enterprise risk for a tax exempt entity based upon responses required to complete an electronic tax form having multiple schedules, each schedule having a request for information, the method comprising;
organizing the requests for information into a plurality of categories;
receiving responses input to an electronic questionnaire;
assigning a risk factor for each of the received responses;
creating a risk range for each the plurality of categories to provide an indication of risk;
computing a risk score for each of the plurality of categories using the assigned risk factors; and
comparing the computed risk score to the risk range.

13. The method of claim 12 further comprising:
setting a flag for each of the plurality of categories indicating that the computed risk score falls within the computed risk range.

14. The method of claim 13, further comprising:
generating a diagnostic report including a list of the plurality of schedules and an indicator associated with each of the plurality of categories based the set flag to indicate that each of the plurality of categories includes at least one of a risk or no risk.

15. A tax risk assessment system for use with a computer network and for assessing a tax risk for a tax exempt entity, the system comprising:
a computer server, coupled to the computer network, the computer server including a software application to assess a tax risk based on a information provided to complete a tax form filed by non-profit organizations, the tax form including a plurality of schedules;
a computing device, coupled to the computer network, the computing device including a user interface to review the software application and to provide information to the software application, wherein the software application includes a program that when executed generates information to complete the tax form, a diagnostic report, and a risk assessment report.

16. The tax risk assessment system of claim 15, wherein the software application includes a plurality of categories for assessing the tax risk, each of the categories being organized according to the information required to complete that tax form and the plurality of schedules.

17. The tax risk assessment system of claim 16, wherein the at least one of the plurality of categories is organized based on information provided to more than one of the schedules.

18. The tax risk assessment system of claim 17, wherein the plurality of categories includes one or more of a governance category, a compensation category, a financial analysis category, a conflict of interest category, a compliance with the law category, and an activity category.

19. The tax risk assessment system of claim 18, wherein the information required to complete the tax form and the plurality of schedules is assigned a risk factor used to determine a level or risk associated with the information.

20. The tax risk assessment system of claim 19, wherein the software application includes a risk range each of the plurality of categories and a comparator to compare the risk range to a total of risk factors.
